(19) United States
(12) Patent Application Publication
(10) Pub. No.: US 2018/0125170 A1
(43) Pub. Date: May 10, 2018

(54) Reversibly Modifying the Optical Appearance of a Piece of Apparel

(71) Applicant: adidas AG, Herzogenaurach (DE)

(72) Inventors: Jan Hill, Grossenseebach (DE); Clemens Paul Dyckmans, Erlangen (DE)

(21) Appl. No.: 15/803,319

(22) Filed: Nov. 3, 2017

(30) Foreign Application Priority Data
Nov. 4, 2016 (DE) 102016221669.4

(51) Int. Cl. A43D 8/16; A41D 27/08; A41D 15/00; A43B 3/00; A43B 23/24; G05B 19/402; B25J 13/08

(52) U.S. Cl. CPC A43D 8/16; A41D 27/08; A41D 15/005; G06T 7/0008; A43B 23/24; G05B 19/402; B25J 13/085; A43B 3/0005

(57) ABSTRACT

Described is an apparatus for reversibly modifying the optical appearance of a piece of apparel. The apparatus may include a position-determining system for determining the position of the piece of apparel, a projecting system for projecting colors, images and/or patterns onto the piece of apparel, and a shape-modifying system for modifying the shape of the piece of apparel, e.g., the surface of the piece of apparel.

### CROSS REFERENCE TO RELATED APPLICATION

This application is related to and claims priority benefits from German Patent Application No. DE 10 2016 221 669.4, filed on Nov. 4, 2016, entitled Apparatus and Method for Reversibly Modifying the Optical Appearance of a Piece of Apparel (“the '669 application”). The '669 application is hereby incorporated herein in its entirety by this reference.

### FIELD OF THE INVENTION

The present invention relates to an apparatus and/or a method for reversibly modifying the optical appearance of a piece of apparel.

### BACKGROUND

Providing individual designs for pieces of apparel can be an important factor for customer satisfaction. Therefore, many efforts are made by the industry to involve customers in the design process of a piece of apparel as early as possible, allowing a customer to develop its own unique apparel design.

A common approach is to use computer-aided methods that allow visually modeling design proposals, e.g., in a 3D modeling software. The models can then be provided with colors, textures, patterns, images, etc. to create an almost realistic impression of the piece of apparel. However, a meaningful evaluation of apparel designs on a computer screen is difficult. On the one hand, controlling a corresponding 3D modeling software requires advanced computer skills. On the other hand, a computer screen can only provide an approximate impression of the piece of apparel.

To provide customers and apparel designer with a more realistic impression of a piece or apparel before it is manufactured, real prototypes of the piece of apparel have to be produced. However, such prototypes are typically inflexible because it is difficult or even impossible to modify them, if changes in the design are desired.

Therefore, methods and systems have been developed to project a design onto a 3D model of a piece of apparel in order to change its appearance by changing the projection.

Such a projecting method and apparatus is disclosed by the online article “Mirror Mirror”, available on http://mid.kaist.ac.kr/projects/mirror/, last visited on Aug. 3, 2016.

A further projecting method and apparatus is disclosed by the online article “Projection-Based Augmented Reality FTW!”, available on http://www.augmented.org/blog/2012/06/projection-based-augmented-reality-ftw/, last visited on Aug. 4, 2016, wherein colors are projected onto the surface of a shoe.

However, the described systems still have major limitations regarding the flexibility for a designer and/or customer to freely modify the overall design of the piece of apparel and to obtain a realistic impression of its final appearance.

### SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various embodiments of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings and each claim.

According to certain embodiments, an apparatus for reversibly modifying an appearance of a piece of apparel is provided. The apparatus may include a position-determining system for determining a position of the piece of apparel; a projecting system for projecting at least one of colors, images, or patterns onto the piece of apparel; and a shape-modifying system for modifying a shape of the piece of apparel into a modified shape.

In some embodiments, in response to the shape of the piece of apparel being modified via the shape-modifying system into a modified shape, the projecting system may adapt the projecting of the at least one of colors, images, or patterns in accordance with the modified shape. The projecting may include projecting at least one of different colors, different images, or different patterns onto different areas of the piece of apparel.

The shape-modifying system may include at least one component that is at least one of: attachable to the piece of apparel; or removable from the piece of apparel. The piece of apparel may be a shoe, and the at least one component may include at least one of: a heel, a heel cap, a quarter, a top piece, a throat, a vamp, a welt, a side cage, a toe cap, a topline, shoelaces, a tongue, or a sole. The at least one component may include an identification chip to provide information enabling the apparatus to determine a type of the at least one component; or the at least one component may include a sensor-detectable marker configured for facilitating detection of at least one of a position or an orientation of the at least one component. The apparatus may further include a grid for receiving the at least one component so as to be located on the grid; and a visual recognition system for observing the grid, where the visual recognition system may detect removal of the at least one component from the grid.

In some embodiments, the position-determining system may determine a change in position of the piece of apparel. The projecting system may also adapt the projecting in accordance with the determined change in position of the piece of apparel. At least one of determining a change in position of the piece of apparel or adapting the projecting may be performed in real-time.

The position-determining system may include at least one of: a camera to obtain information for enabling the apparatus to determine at least one of the position or a change in position of the piece of apparel based on image recognition; a photonic mixing sensor or other depth sensor; or a marker-based tracking system that includes at least one sensor-detectable marker attached to the piece of apparel and at least one sensor for detecting at least one of the position or a change in position of the piece of apparel.

In some embodiments, the apparatus further includes at least one of: a position-modifying system for modifying the position of the piece of apparel into a modified position; or an input system configured for accepting an input command.

The position-modifying system may include a robot arm, and the modified position of the piece of apparel may be determined by the robot arm. The robot arm may include a force momentum sensor for further determining the position of the piece of apparel.

The input system may facilitate controlling at least one of the projecting system or the position-modifying system. The input system may include at least one area of a surface of the piece of apparel. The input system may include a gesture recognition system. The input command may be submitted by a user.

According to certain embodiments, a method for reversibly modifying the optical appearance of a piece of apparel can include determining a position of the piece of apparel; projecting at least one of colors, images, or patterns onto the piece of apparel; and modifying a shape of the piece of apparel into a modified shape.

In some embodiments, modifying the shape includes at least one of: attaching at least one component to the piece of apparel; or removing at least one component from the piece of apparel. In response to the shape of the piece of apparel being modified into the modified shape, the projecting of at least one of colors, images, or patterns may be adapted in accordance with the modified shape. The projecting at least one of colors, images, or patterns onto the piece of apparel may include projecting at least one of different colors, different images, or different patterns onto different areas of the piece of apparel. The piece of apparel may be a shoe.

In some embodiments, the method further includes at least one of the following: modifying the position of the piece of apparel, or accepting an input command. Accepting an input command may cause a modification to at least one of the projecting or position of the piece of apparel. The input command may be applied to at least one area of the piece of apparel. The input command may be detectable by a gesture recognition system. The input command may be submitted by a user.

Determining the position may include determining a change in position of the piece of apparel. The projecting may include adapting the projecting in accordance with the determined change in position of the piece of apparel. At least one of determining the change in position of the piece of apparel or adapting the projecting may be performed in real-time.

According to certain embodiments, a non-transitory computer-readable storage medium may have stored therein instructions that, when executed by one or more processors of a computer system, cause the computer system to at least: determine a position of a piece of apparel; cause projecting of at least one of colors, images, or patterns onto the piece of apparel; and cause a modifying of a shape of the piece of apparel into a modified shape.

In some embodiments, the instructions further cause the computer system to, in response to the shape of the piece of apparel being modified into a modified shape, cause the projecting of at least one of colors, images, or patterns to be adapted in accordance with the modified shape.

In some embodiments, the instructions may cause the computer system to at least one of: cause the position of the piece of apparel to be modified, or accept an input command.

In some embodiments, the instructions may cause the computer system to: determine a change in position of the piece of apparel; and cause the projecting to be adapted in accordance with the determined change in position of the piece of apparel. The instructions may further cause the computer system to: determine the change in position of the piece of apparel or cause the projecting to be adapted in real-time.

In some embodiments, the instructions further cause the computer system to: accept an input command; and cause a modification to at least one of the projecting or a position of the piece of apparel in response to the input command.

### BRIEF DESCRIPTION OF THE DRAWINGS

In the following detailed description, embodiments of the invention are described referring to the following figures, in which:

FIG. 1 shows an apparatus according to some embodiments;

FIGS. 2 and 3 show a piece of apparel according to some embodiments; and

FIG. 4 shows a piece of apparel and components according to some embodiments.

### BRIEF DESCRIPTION

The above mentioned problem is at least partly solved by features described herein, such as within the context of an apparatus, a method, and/or a computer program.

According to some aspects, an apparatus for reversibly modifying the appearance of a piece of apparel is provided. The apparatus may include a position-determining system for determining the position of the piece of apparel, a projecting system for projecting colors, images and/or patterns onto the piece of apparel, and a shape-modifying system for modifying the shape of the piece of apparel, in particular its surface.

Besides changing a projection, applicant has found that enabling a modification of the shape (e.g., in particular the surface) of the piece of apparel may further improve the overall design process. The piece of apparel may, for example, be provided as an essentially single-colored physical 3D model that may be composed of a plurality of connectable individual elements. In some embodiments, the piece of apparel may be a white or substantially single-colored piece of garment. Having an adjustable shape of the piece of apparel may facilitate the evaluation of a large number of different overall designs in a limited amount of time. The step of generating a new physical 3D model from scratch for each new design proposal based on a new shape may be omitted. Instead, the shape of the piece of apparel may be modified by, for example, attaching further elements to a physical 3D (base) model and therefore changing its shape. Moreover, already attached elements may also be removed again. After such a change, colors, patterns, texture, images, etc. may be projected again onto the modified shape of the piece of apparel.

The initial position of the piece of apparel may be automatically determined. Then, the projection may be adjusted to be in accordance with the determined position, leading to a high-quality projection of the colors, textures, patterns, images, etc. The piece of apparel alone (and not its surrounding environment) may be illuminated by the projecting system. This may further improve the quality of the impression of the illuminated piece of apparel, leading to an essentially realistic appearance.

While the described apparatus is suitable for evaluating designs of a piece of apparel (such as a shoe), in general, it may also be used to evaluate the designs of other physical objects, such as sports devices, etc.

The shape-modifying system for modifying the shape may include at least one component attachable to the piece of apparel and/or at least one component removable from the piece of apparel. In some embodiments, individual components may be flexibly applied to or removed from the piece of apparel in order to modify its shape. For example, decorative elements like stripes or functional elements may be attached to the piece of apparel. Furthermore, already attached components may be removed and, for example, replaced by other components. This may enable a modification of the shape of the piece of apparel without having to rebuild it from scratch.

When the shape of the piece of apparel is modified, the projecting system may adapt the projecting of colors, images and/or patterns in accordance with the modified shape. Projecting colors, images and/or patterns onto the piece of apparel may include projecting different colors, images, and/or patterns to different areas of the piece of apparel.

When components are attached or removed from the piece of apparel, new areas may arise on the surface of the piece of apparel. Any area of the piece of apparel may be illuminated by an individual color, pattern or image. Furthermore, new areas may be defined by splitting existing areas into two or more new areas. In addition, existing areas may be merged to form one new single area.

Furthermore, the piece of apparel may be a shoe, and the at least one component attachable or removable to/from the shoe may include at least one of a heel, a heel cap, a quarter, a top piece, a throat, a vamp, a welt, a side cage, a toe cap, a topline, shoelaces, a tongue, or a sole. All of these components have decisive influence on the outer appearance and thus the design of a shoe.

In addition, the at least one component attachable and/or removable to/from the piece of apparel may include an identification chip. The identification chip may include information enabling the apparatus to determine the type of the at least one component. Additionally or alternatively, the at least one component may include a sensor-detectable marker usable for detecting the position and/or orientation of the component.

When a component is attached to the piece of apparel, the shape of the piece of apparel may be extended (or reduced when a component is removed) and may therefore change. In such a case, a composed piece of apparel is created and the apparatus has to determine the new shape of the composed piece of apparel for adjusting the projection onto the surface of the composed piece of apparel in order to bring the projection in conformity with the new shape. However, image analysis-based approaches also may be suitable for identifying the piece of apparel or a component.

Furthermore, the at least one component may be located on a grid, wherein the grid may be observed by a visual recognition system, wherein the visual recognition system may be configured to detect that the at least one component is removed from the grid.

At least one component may be placed onto the grid. The grid may be attached to the apparatus and may be observed by a suitable visual recognition system. When at least one component is selected for being applied to the piece of apparel and is therefore removed from the grid, the apparatus may detect the removal of the component(s) from the grid by the visual recognition system and may therefore know that the removed component(s) is or are intended for being applied to the piece of apparel.

In addition, the apparatus may include a position-modifying system for modifying the position of the piece of apparel and/or an input system for accepting an input command.

When, for example, the shape and/or the projection changes, the result can be evaluated to determine whether it meets the expectations of a customer or an apparel designer, and it may be desirable to consider the piece of apparel from different perspectives. Therefore, the piece of apparel may be moved while the customer or the designer may remain at its original position.

In more detail, the change of the position may include a translational movement along at least one axis or a rotation of the piece of apparel along at least one rotation axis. In addition, a translational movement and a rotation may be applied simultaneously.

The change in position of the piece of apparel may be controlled by input commands applied to the apparatus enabling the customer or the apparel designer to stand still in one place while evaluating the piece of apparel from different directions.

The position-determining system for determining the position may be configured to determine a change in position of the piece of apparel and the projecting system may be configured to adapt the projecting in accordance with the determined change in position of the piece of apparel.

For being able to adjust the projection when the piece of apparel is moved around, the change of the position may be determined. The detected change of the position may then be communicated to the projection system, e.g. a laser device or a beamer device, or any other type of suitable projector, which may then adjust the projection to create a projection onto the surface of the moved piece of apparel at its new position. In addition, a plurality of projectors may be used such that each projector may project to a specific area of the piece of apparel.

The adjustment of the projection may be achieved by considering the distance of at least one translational movement in any direction and by considering the angle and direction of at least one rotation. Determining a change in position of the piece of apparel and/or adapting the projection may be performed in real-time.

To maintain a suitable impression from the point of view of a customer or an apparel designer, even during movement of the piece of apparel, the determination of the change in position may be performed such that no—or at least almost no—delay in adapting the projection becomes recognizable for the human eye. It is known that the term “real-time” comprises tolerances. Therefore, a short delay in the process of determining the change in position and adapting the projection may still lead to an essentially realistic impression for a human viewer being generated so that the viewer may believe that a finally manufactured piece of apparel is moved around, and not just an illuminated model thereof.

The position-determining system may include at least one of a camera configured to determine the position and/or the change in position based on image recognition, a depth sensor (e.g., a photonic mixing sensor), or a marker-based tracking system. The marker-based tracking system may include at least one sensor-detectable marker attached to the piece of apparel and/or to a component and at least one sensor usable for detecting the position and/or the change in position of the piece of apparel and/or of the components.

Using a camera may enable the use of image-based recognition algorithms for determining the position or the change in position of the piece of apparel and/or of the components. When using a depth sensor, the radiated light may be determined and corresponding algorithms may be used to determine the position or the change of position of the piece of apparel and/or of the components.

The piece of apparel may include at least one sensor-detectable marker. Such a marker may be a marker of a commercially available position tracking system. Also, a combination of different kinds of chips or markers may be included in and/or on the piece of apparel or the components. One type of chip may be used for determining the position and orientation of the piece of apparel and/or of the components, while the other type of chip may be used for identifying the type of piece of apparel and/or of the components.

When the piece of apparel and/or the components include sensor-detectable markers of a position tracking system, the apparatus may determine the position and orientation of the piece of apparel (or of a piece of apparel composed by a plurality of components) without having to use the aforementioned image recognition or radiated light measurement. This may improve the position determination when insufficient lighting conditions prevail.

Furthermore, the camera-based, the depth sensor-based, and the sensor-based position determination may be combined. A combination of approaches may further improve the accuracy of the position determination, which may lead to an improved projection applied to the piece of apparel.

The position-modifying system for modifying the position of the piece of apparel may be a robot arm wherein the modified position of the piece of apparel may be determined by the robot arm. The robot arm may include a force momentum sensor for further determining the position of the piece of apparel.

Instead of manually moving the piece of apparel for changing its position, a robot arm may be used. The robot arm may comprise a device similar to a human hand which may be configured to grab the piece of apparel. The robot arm may modify the position of the piece of apparel by either reacting to movement commands provided by a customer or an apparel designer or by moving the piece of apparel along a predefined path. Using a robot arm for modifying the position may provide stable views of the piece of apparel.

Providing at least one force momentum sensor, for example in the robot arm, may further improve determining a change of the position of the piece of apparel.

Furthermore, the above described input system for accepting an input command may be configured for controlling the projecting system and/or the position-modifying system for modifying the position of the piece of apparel.

Besides changing the position of the piece of apparel along a predefined path as described above in respect to the robot arm, a customer or an apparel designer may also control and change the projection applied to the piece of apparel. This may include changing or varying the colors, images, and/or patterns projected onto the piece of apparel. In addition, contrast and saturation or any other color-related parameter may be modified.

The input system for accepting an input command may be or include at least one area of the surface of the piece of apparel itself. Additionally or alternatively, the input system for accepting an input command may be a gesture recognition system. Particularly, the input command may be submitted by a user.

To provide an intuitive way for entering input commands, the piece of apparel may be used as an input device. For example, if a customer or a designer wants a specific area to be illuminated with a specific color, he may touch this area with his finger. The apparatus may then recognize this gesture and may in reaction thereto change the projected color of the area. In the same way, projected images and/or patterns may be changed.

Many different types of gestures exist that may be suitable for performing the above described actions. For example, the areas of the piece of apparel may be touch-sensitive. In this case, the areas may behave similar to common touchscreens. This may for example be achieved by the above-mentioned force momentum sensor of the robot arm. In more detail, when pressure is applied to an area of the piece of apparel held by the robot arm, the resulting force (for example a rotation force) is transmitted to the robot arm which may then determine the area of the piece of apparel to which the pressure was applied by use of the force momentum sensor. However, touchless gesture recognition may be also used. When a customer or a designer moves his finger towards a specific area or touches a specific area, the above described camera-based image recognition and/or the depth sensor may be used to determine that the finger points towards a specific area or touches the specific area. In reaction thereto, at least one of the above described actions may be executed. However, besides pointing or touching gestures, other gestures, like waving etc., may be suitable for controlling the apparatus.

According to another aspect, a method for reversibly modifying the appearance of a piece of apparel is provided. The method may include determining the position of the piece of apparel, projecting colors, images and/or patterns onto the piece of apparel, and modifying the shape of the piece of apparel, such as its surface. Furthermore, the method may provide the optical impression that the piece of apparel is made from a material including the projected colors, images, and/or patterns.

Modifying the shape may include attaching at least one component to and/or removing at least one component from the piece of apparel.

When the shape of the piece of apparel is modified, the projection of colors, images, and/or patterns may be adapted in accordance with the modified shape.

Projecting colors, images, and/or patterns onto the piece of apparel may include projecting different colors, images and/or patterns to different areas of the piece of apparel.

The piece of apparel may be a shoe.

The method may further include at least one of modifying the position of the piece of apparel or accepting an input command.

Determining the position may include determining a change in position of the piece of apparel, and projecting may include adapting the projection in accordance with the determined change in position of the piece of apparel.

Determining a change in position of the piece of apparel and/or adapting the projecting may be performed in real-time.

Accepting an input command may cause the method to modify the projection and/or to modify the position of the piece of apparel.

The input command may be applied to at least one area of the piece of apparel itself and/or the input command may be detectable by a gesture recognition system and/or wherein the input command is submitted by a user.

This method may be performed in connection with the above described apparatus and therefore may benefit from the same aspects as already presented above in respect to said apparatus.

A further aspect may relate to a computer program that includes instructions for performing any of the above described methods.

### DETAILED DESCRIPTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

In the following, embodiments and variations of the present invention are described in detail with respect to the figures.

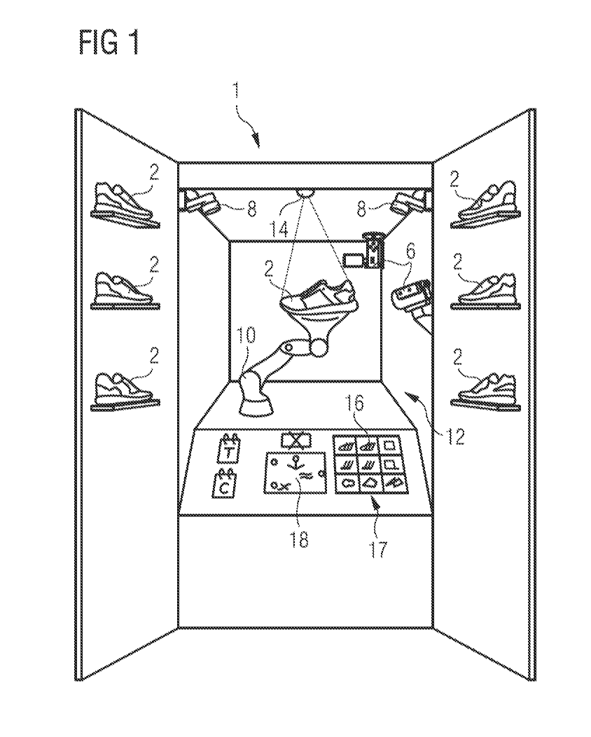

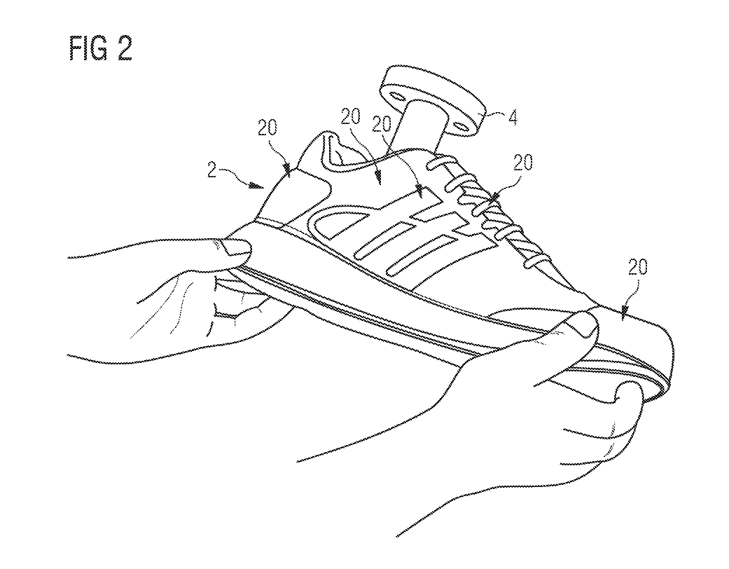

FIG. 1 shows an apparatus 1 according to some embodiments. The apparatus 1 includes a framework 12 that surrounds a specific area in which a piece of apparel may be moved around. The piece of apparel is applied with a sensor-detectable marker 4 (e.g., FIG. 2) which may be tracked by position tracking sensors 8. In addition, at least one camera 6 may be placed around the framework 12 to determine the position of the piece of apparel by image recognition techniques. To modify the position of the piece of apparel, a robot arm 10 may be provided. Projector 14 may be used to apply a projection onto the surface of the piece of apparel, including colors, images and/or patterns. The apparatus 1 may be controlled by user interface 18. Furthermore, for orchestrating the interaction of all the above described devices, a computing system or device (not shown) may be included in apparatus 1, allowing specific calculations, receiving user input from the user interface 18, and enabling communication between the devices of apparatus 1. For example, the computing system or device may include a processor and a non-transitory computer-readable medium comprising processor-executable instructions to cause the processor to perform functions described herein.

As may be seen in FIG. 1, a single projector 14 is placed above the piece of apparel. However, it is also possible to use more than one projectors 14 to illuminate the piece of apparel. When using more than one projector 14, it is possible to illuminate the piece of apparel inside the framework 12 from different directions at the same time. This may allow several persons to evaluate a design of the piece of apparel at the same time from different positions around the framework 12. Furthermore, when more than one projector is used, each projector may create a projection onto a specific area of the piece of apparel.

The piece of apparel can be virtually any kind of apparel. However, generally any kind of physical object, e.g., sports devices and shoes 2, may be used in connection with apparatus 1. In the following, it is assumed that the piece of apparel is a physical model of a shoe 2 according to FIGS. 2-4.

In the past, when, for example, a new shoe was developed or when a customer wanted to individually customize the appearance of a shoe, a large number of real physical models of the shoe had to be designed, manufactured, and evaluated. When the surface design or shape was considered inappropriate because the surface design or the shape didn't correspond to the wishes of the customer or apparel designer, the physical model oftentimes had to be fully discarded because it was not possible to incorporate changes of the surface design or shape into a completed physical model of a shoe 2. Therefore, a new physical model of the shoe 2 had to be manufactured for every desired change of the surface design or of the shape of the shoe.

To overcome these issue, apparatus 1 may be used for evaluating designs, including shape and surface designs of shoes. Before the designs are evaluated, a physical model of the shoe 2 is generated. This may, for example, be done by a 3D printer. Such a printer may generate an essentially single-colored three dimensional physical model of the shoe 2. However, besides 3D printing, any other suitable method for generating a physical model of the shoe 2 may also be suitable, including, but not limited to, casting or molding. With the three-dimensional physical model of the shoe 2 provided, a plurality of surface designs may be applied one after another to the surface of the shoe 2 by the projector 14. Projecting surface designs onto the three-dimensional physical model of the shoe 2 allows evaluation of a large number of color designs and pattern designs in a short period of time since a plurality of projections may be applied to the physical model of the shoe 2 without having to modify the physical model of shoe 2 itself.

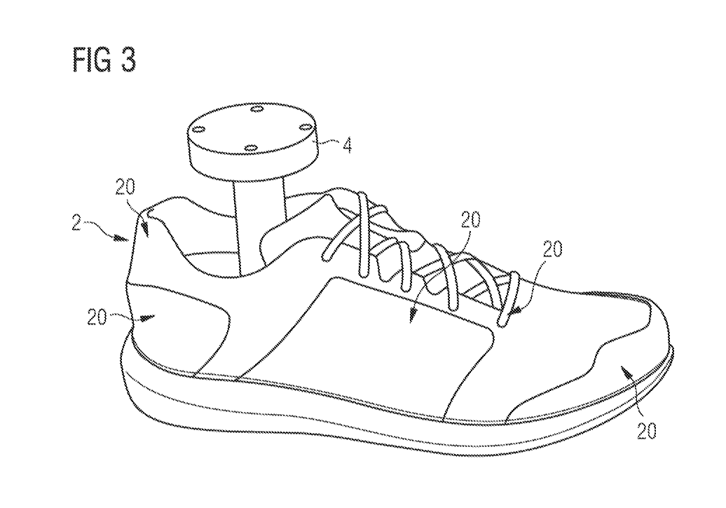

With reference to FIGS. 2-3, a shoe includes several areas 20, formed, for example, by its heel, its sole, or its quarter etc. A desired design may define a specific color, image and/or pattern for each of said areas 20. Therefore, the at least one projector 14 of the apparatus 1 may project a first color onto a first area 20 of the surface of the physical model of the shoe 2 while a second color is projected onto a second area 20 of the physical model of the shoe 2. Generally, the number of different areas 20 is not limited. Therefore, colorful pieces of apparel may be designed, including a plurality of areas 20 with different colors, images and/or patterns.

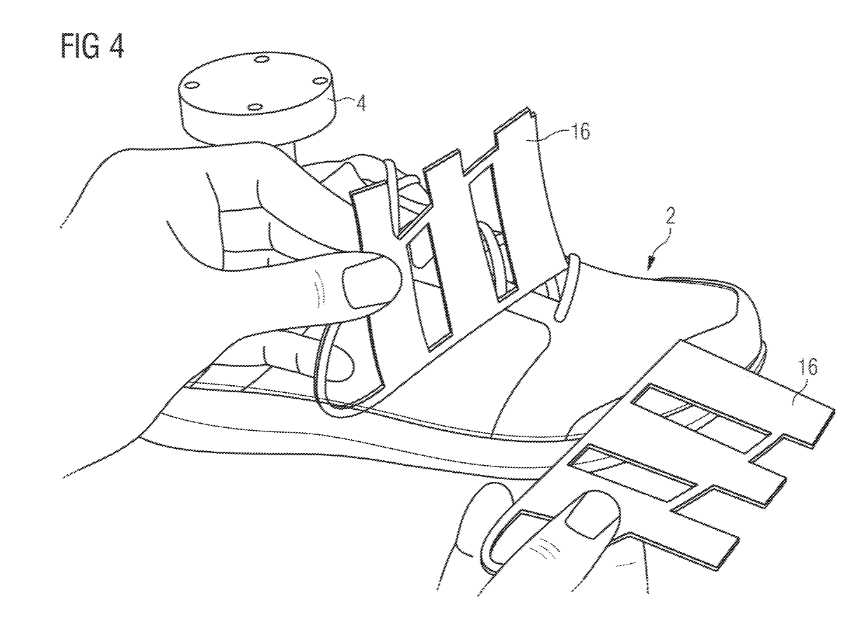

While a change of a design to be projected on the surface of the physical model of the shoe 2 may only affect the colors of at least one area 20 of its surface, another design proposal may also provide changes of the shape of the shoe. Therefore, a physical model of the shoe 2 may be produced (e.g., with reference to FIG. 4), wherein components 16 of the shoe are exchangeable. In addition, further parts, like decorative elements etc., may be attached to the physical model of the shoe 2. These components 16 may be subsequently removed again from the physical model of the shoe 2. The attachable and removable components 16 may also be produced by a 3D printer or by any other suitable means or method. The components 16 may include a plurality of heels, quarters, decorative elements, soles, toe caps, throats, and the like. Each of the components 16 may include a different shape. Thus, the components 16 may be used to compose a physical model of a shoe 2 according to the specification of a specific design proposal. According to this modular principle, a plurality of different shapes of the physical model of the shoe 2 may be generated by putting together the single set of components 16. In addition, it is also possible to generate a base part of a physical model of a shoe 2, already including the final basic shape of the shoe, which may then be only applied with decorative elements.

Each component 16 may include at least one area 20 to be illuminated by at least one color, at least one image and/or at least one pattern by the at least one projector 14 of apparatus 1. For example, a single color may be projected onto the heel part of the physical model of the shoe 2, while a pattern is projected onto the quarter of the physical model of the shoe 2. In addition, an image may be projected onto the side part of the physical model of the shoe 2. Such an image may, for example, show the portrait of a famous athlete, numbers, logos, lettering, etc. The patterns may include geometric shapes or may be used to simulate the appearance of different fabrics, like leather or plastic etc. Therefore, the appearance of different materials also may be simulated by apparatus 1.

When the physical model of the shoe 2 is completely composed, a sensor-detectable marker 4 may be incorporated into or attached to the physical model of the shoe 2. Furthermore, an identification chip, e.g., a Near-Field-Communications (NFC) chip, may be incorporated into or attached to the physical model of the shoe 2 allowing identification of the model type of the shoe 2. The physical model of the shoe 2 having the sensor-detectable marker 4 may be placed into the framework 12 the apparatus 1. The apparatus 1 may determine the position and orientation of the physical model of the shoe 2 by the position tracking sensors 8 that are able to detect the sensor-detectable marker 4 of the physical model of the shoe 2. The position tracking sensor 8 may belong to a position tracking system able to determine and track the position and orientation of the marker 4 in three-dimensional space. The three-dimensional space may be formed by the framework 12. The position and orientation of the sensor-detectable marker 4 corresponds to the position and orientation of the physical model of the shoe 2. When both the position and the orientation of the physical model of the shoe 2 are determined, the at least one projector 14 may be configured to project the desired colors, images, and/or patterns onto the surface of the areas 20 of the physical model of the shoe 2.

Furthermore, each component 16 may include its own sensor-detectable marker 4, e.g., allowing the sensors 8 of apparatus 1 to individually determine the position and/or orientation of each component 16 forming the physical model of the shoe 2. The position and orientation information of each individually tracked component 16 may be used for adjusting the projection so as to cover the shape of the composed physical model of the shoe 2.

Each component 16 may include its own NFC chip. A reader may be incorporated in the shoe 2 to read the respective NFC chip and identify which component is attached to the shoe. The shoe 2 may communicate the detected component 16 or components 16 to the apparatus 1 by means of any suitable communication means.

Additionally or alternatively, at least one component 16 may be placed onto a grid 17 for selection. The grid 17 may be located on or near the apparatus 1. The grid 17 may be observed by at least one camera 6 or any other visual recognition system. When at least one component 16 is selected for being applied to the physical model of the shoe 2 and therefore removed from the grid 17, apparatus 1 may detect the removal of the component 16 or components 16 from the grid 17 and therefore may know that the removed component 16 or components is/are intended for being attached to the physical model of the shoe 2. The at least one components 16 for example may be manually removed by hand. Each component 16 may have a predetermined position on the physical model of the shoe 2 to which it may be applied. When it is determined that at least one component 16 is removed from the grid 17 and applied to the physical model of the shoe 2, the apparatus 1 may instruct projector 14 to adjust the projection onto the physical model of the shoe 2 accordingly such that the at least one component 16 applied to the shoe 2 is illuminated correctly.

Besides using a position tracking system for determining and tracking the position and orientation of the marker 4, it is also possible to utilize at least one camera 6 (e.g., placed around the framework 12) to determine the position and orientation of the physical model of the shoe 2 or the position and orientation of at least one component 16. Furthermore, a depth-sensor, like a photonic mixing sensor or a Microsoft Kinect® controller, may be used for determining the position and the orientation of the physical model of the shoe 2 or of the position and orientation of at least one component 16. However, a combination of the two or more of the above presented devices for determining the position and orientation also may be coupled and may therefore be used simultaneously. For example, filtering algorithms may be applied to determine the most accurate position value provided by one of the devices.

In particular, the cameras 6 or the depth sensor may also be able to detect the presence of any component 16 added to the physical model of the shoe 2.

After the position of the physical model of the shoe 2 and/or of the components 16 have been determined, the physical model of the shoe 2 may also be moved around in the framework 12. The position and orientation may accordingly change. This may require a continuous redetection of the position and orientation to enable a corresponding adjustment of the at least one projector 14 such that the areas 20 are still illuminated according the design being currently evaluated. Therefore, the above discussed devices (cameras 6, position tracking system, and depth sensor) may be configured for performing a detection of a change of the position, essentially in real-time.

Providing an exact projection onto the different areas 20 of the physical model of the shoe 2 may require that the at least one projector 14 is configured according to the shape and position and/or orientation of the physical model of the shoe 2.

Therefore, the above described identification chip, e.g. an NFC chip, may provide the type of the physical model of the shoe 2 to apparatus 1. In more detail, each of the components 16 may also include an individual identification chip. Then, when the physical model of the shoe 2 is located inside the framework 12, apparatus 1 is able to detect the type of all the used components 16. The computing device of apparatus 1 may receive shape-related information for each type of component 16 from a database. The shape-related information of the components 16 may include the size and the place where the components 16 may be located on the physical model of the shoe 2, as well as other appearance-related information, like a default color etc. The computing device of apparatus 1 may be able to combine the shape-related information of the components 16 with a virtual 3D wireframe model of the physical model of the shoe 2. In more detail, the computing device may merge the shape-related information and the virtual 3D wireframe model of the shoe 2 so as to form one virtual object inside the computing device which may then be used as a basis for calculations required for adjusting the projection onto the physical object of the shoe 2.

In more detail, the shape-related information of the components 16 may include 3D wireframe data representing the geometry of the components 16. Furthermore, the physical model of the shoe 2 also may be represented by a virtual 3D wireframe model. Considering the virtual 3D wireframe models of both the components 16 and the physical model of the shoe 2 as well as the information regarding the place where the components 16 may be attached allows the computing device to combine the virtual 3D wireframe models of the various components 16 with the virtual 3D wireframe model of the shoe 2 to form one uniform 3D wireframe model of the overall arrangement. For example, the physical model of the shoe 2 may consist of a sole, an upper part, and two decorative elements of which one is applied to the inner side and one is applied to the outer side of the shoe.

When the physical model of the shoe 2 is placed into the framework 12 of apparatus 1, all components 16 may be detected by means of the included identification chip. However, the identification also may be performed by the at least one camera 6 using a shape detection algorithm. Then, the computing device may retrieve the shape-related information and the information regarding the place where the component 16 may be attached. A sole may commonly be placed at the bottom of the physical model of the shoe 2, whereas an upper part is commonly placed on top of the sole. Furthermore, the information regarding the place where the component 16 of the two decorative elements may be attached may define that these specific types may only be placed on the inner and outer side of the physical model of a shoe 2. Based on this information, the computing device of apparatus 1 may be able to merge the corresponding 3D wireframe model of the four components 16 to form a uniform 3D wireframe model of the physical model of the shoe 2. In addition, the 3D wireframe models of the components 16 may also define at least one area 20 on the surface of the corresponding component 16. Therefore, the 3D wireframe model defines the overall shape as well as the different areas 20 on the surface of the physical model of the shoe 2. Such a 3D wireframe model may then be used to calculate the projections of the at least one projector 14 of apparatus 1. This may be done by determining the position and orientation of the physical model of the shoe 2 as described above. This information may be combined with the uniform 3D wireframe model of the physical model of the shoe 2, allowing the computing device to calculate how the projection is to be applied to the surface of the physical model of the shoe 2. The results of the calculation may allow an exact configuration of the at least one projector 14 of apparatus 1. As a result, the at least one projector 14 is able to project the desires colors, images and/or patterns to the corresponding areas 20 of the surface of the physical model of the shoe 2. Such a projection may create a nearly realistic impression such that human viewer may believe that he is watching a real shoe.

Furthermore, this approach may allow exchange of components 16 of the physical model of the shoe 2 during the process of evaluating a design. In detail, a customer or an apparel designer may attach and/or remove components 16 of the physical model of the shoe 2 while being located in the framework 12 of apparatus 1. Sensor for detecting the identification chips and/or the cameras 6 may detect any change of the shape of the physical model of the shoe 2 in real-time. Therefore, the projection onto the surface may also be adjusted in real-time. When, for example, a decorative element is attached to or removed from the physical model of the shoe 2, at least one new area 20 will arise. In reaction thereto, the at least one projector 14 may immediately adjust the projection and project a suitable color, image, and/or pattern to the at least one new area 20. Therefore, apparatus 1 allows customers and apparel designer to perform a seamless adjustment of the shape of the physical model of the shoe 2, without interrupting the projection.

Besides changes of the shape of the physical model of the shoe 2, it also desirable to provide a convenient way of adjusting colors, images, and/or patterns of the areas 20 of the surface of the physical model of the shoe 2 during the design evaluation process.

One way of selecting colors, images, and/or designs for an area 20 may be to use the user interface 18 of apparatus 1. The user interface 18 may show a picture of the physical model of the shoe 2 on a screen. This screen may be a touchscreen. A customer or an apparel designer may select an area 20 of the physical model of the shoe 2 by touching the corresponding area 20 on the touchscreen. The customer or apparel designer may further select a color, an image, and/or a pattern to be projected onto this area 20 from a menu shown on the screen. This may cause the at least one projector 14 to adjust the projection accordingly. The process of adjusting the projection may also be performed in real-time.

Besides a touchscreen, any other suitable input device may be used, e.g. a mouse, a keyboard etc.

A further way for selecting different colors, images and/or patterns for an area 20 may be to touch an area 20 with a finger. The apparatus 1 may then recognize this gesture and may in reaction thereto change the color, image, and/or pattern of the area 20.

Many different types of gestures exist that may be suitable for performing the above described changing of colors, images, and gestures. For example, the areas 20 of the physical model of the shoe 2 may be touch-sensitive. In this case, the areas 20 may behave similar to common touchscreens. This may be achieved by incorporating a touch-sensitive sensor into the surface of each component 16. However, touchless gesture recognition may be used also. When a customer or a designer moves his finger towards a specific area 20 or touches a specific area 20, the above described camera-based image recognition and/or the depth sensor may be used to determine that the finger points towards a specific area 20 or touches the specific area 20. In reaction thereto, at least one of the above described actions may be executed. However, besides pointing or touching gestures, other gestures, like waving etc., may be suitable for controlling the apparatus 1. For example, a projection may be reset by shaking the physical model of the shoe 2. This may result in a single-colored projection applied to each area 20 of the physical model of the shoe 2. In addition, the reset may lead to a projection of the original design.

In the following, the color, image, and/or pattern selection is described in greater detail.

The above described gestures applied to a specific area 20 of the physical model of the shoe 2 may allow cycling through predefined items of sets. Various types of sets may exist, and four are discussed herein: Color sets, image sets, pattern sets, and mixed sets.

A color set may include a plurality of colors. An image set may include a plurality of images, such as photos of famous athletes etc. Pattern sets may include a plurality of different patterns. A mixed set may include colors, images, and/or patterns. These sets may be defined or modified by a customer or designer, e.g. by using the user interface 18 of apparatus 1. Furthermore, a plurality of sets may be defined per area 20.

Assuming that a color set is pre-selected, then, when a customer or designer performs a gesture as described above, the color of the corresponding area 20 may change from blue to green. When the area 20 is touched again, the color may change from green to yellow. In the same way, the user may cycle though the other types of sets. The same method may be used for cycling through image sets and pattern sets.

However, a customer may also cycle though the different types of sets. While cycling though the items of a set is performed by a first type of gesture, cycling though the sets may be performed by a second type of gesture. When a gesture according to the second type is detected, the projection onto a specific area 20 is not changed, but only a new set is activated. Then, when the first type of gesture is performed, it is cycled through the items of the activated set.

Such mechanism allows a customer or an apparel designer to quickly change the projection onto a specific area 20 without having to use the user interface 18 of apparatus 1.

Besides modifying the shape of the physical model of the shoe 2 and the projection thereon, the position and/or orientation of the physical model of the shoe 2 also may be modified. This may be done manually by grabbing the physical model of the shoe 2 and moving it freely around inside the framework 12 of apparatus 1.

The position of the physical model of the shoe 2 may further be modified by means of a rotatable and/or inclinable platform on which the physical model of the shoe 2 may be placed. Such a platform may be located inside the framework 12 of apparatus 1. The platform may be controlled by entering corresponding commands using the user interface 18 of apparatus 1.

Instead of using a platform, a robot arm 10 may be used for modifying the position of the physical model of the shoe 2. The robot arm 10 may include a device similar to a human hand which may be configured to grab physical model of the shoe 2. The robot arm 10 may modify the position of the physical model of the shoe 2 by either reacting to movement commands provided by a user or by moving the physical model of the shoe 2 along a predefined path.

The predefined path may include the most important positions required for sufficiently evaluating the overall design of the physical model of the shoe 2. For example, the robot arm 10 may at first lift the physical model of the shoe 2 and then rotate it such that a consumer or an apparel designer may be provided with a front view of the physical model of the shoe 2. Then, the robot arm 10 may remain in this position for a specific period of time. Afterwards, the robot arm 10 may move the physical model of the shoe 2 to a next position. Then, the robot arm 10 may again remain in this position for a specific period of time. These steps may be repeated until all predefined positions along the predefined path have been reached once.

Using a robot arm 10 or a platform as described above for modifying the position may provide stable views of the piece of apparel. In comparison, when the piece of apparel is held in hand by a customer or apparel designer, the piece of apparel may always slightly be jiggled because a human hand cannot be kept exactly in one position without any slight movement of the hand.

Furthermore, the robot arm 10 may include at least one force momentum sensor which may further improve determining a change of the position of the physical model of the shoe 2. The position information gathered by said sensor may be communicated to the computing device of apparatus 1. The force momentum sensor information may be used alone or in combination with the position information provided by the position tracking system, the at least one camera 6, and/or by the depth sensor.

Furthermore, the robot arm 10 may use the force momentum sensor to determine the area on the shoe 2 to which pressure is applied. The pressure results in a force which may be transmitted to the robot arm 10, e.g. in terms of a rotation force or the like. The robot arm may determine the area on the shoe 2 to which the pressure was applied by means of the force momentum sensor. Thus, the force momentum sensor may be used to implement a mechanism for determining an area of the shoe 2 that a user has selected by touching said area.

Besides a robot arm 10 or a platform, any other systems may be suitable for modifying the position which may push, pull, lift, rotate, and/or lower the position of the physical model of the shoe 2.

When a design has been fully evaluated and satisfies the wishes of a customer or an apparel designer, the configuration of the design (e.g., including the at least one component 16 that forms the physical model of the shoe 2, and the colors, images, and/or patterns selected for at least one area 20) may be stored in a database. The process of storing may be initiated by using the user interface 18 of apparatus 1. The configuration may then be used to control the manufacturing process of the shoe according to the evaluated design.

One or more of the above described aspects may be implemented in hardware, in software or as a combination of hardware or software. Furthermore, one or more of the above described aspects may be implemented in the apparatus or in terms of a method.

In the following, further examples are described to facilitate the understanding of the invention:

### Example 1

An apparatus for reversibly modifying the appearance of a piece of apparel, the apparatus comprising:
a. means for determining the position of the piece of apparel;
b. means for projecting colors, images and/or patterns onto the piece of apparel; and
c. means for modifying the shape of the piece of apparel, in particular its surface.

### Example 2

The apparatus of example 1, wherein the means for modifying the shape comprise at least one component attachable to the piece of apparel and/or at least one component removable from the piece of apparel.

### Example 3

The apparatus of any of the preceding examples, wherein, when the shape of the piece of apparel is modified, the means for projecting is configured to adapt the projecting of the colors, images and/or patterns in accordance with the modified shape.

### Example 4

The apparatus of any of the preceding examples, wherein projecting of the colors, images and/or patterns onto the piece of apparel comprises projecting different colors, images and/or patterns to different areas of the piece of apparel.

### Example 5

The apparatus of any of the preceding examples 2-4, wherein the piece of apparel is a shoe and wherein the at least one component attachable or removable to/from the shoe comprises one or more of:
a heel,

a heel cap,

a quarter,

a top piece,

a throat,

a vamp,

a welt,

a side cage,

a toe cap,

a topline,

shoelaces,

a tongue,

a sole.

### Example 6

The apparatus of any of the preceding examples 2-5, wherein the at least one component attachable and/or removable to/from the piece of apparel comprises an identification chip, the identification chip comprising information enabling the apparatus to determine the type of the at least one component; and/or wherein the at least one component comprises a sensor-detectable marker usable for detecting the position and/or orientation of the component.

### Example 7

The apparatus of any of the preceding examples 2-6, wherein the at least one component is located on a grid, wherein the grid is observed by a visual recognition system of the apparatus, wherein the visual recognition system is configured to detect that the at least one component is removed from the grid.

### Example 8

The apparatus of any of the preceding examples, further comprising at least one of:
means for modifying the position of the piece of apparel,
means for accepting an input command.

### Example 9

The apparatus of any of the preceding examples, wherein the means for determining the position is configured to determine a change in position of the piece of apparel; and wherein the means for projecting is configured to adapt the projecting in accordance with the determined change in position of the piece of apparel.

### Example 10

The apparatus of example 9, wherein determining a change in position of the piece of apparel and/or adapting the projecting is performed in real-time.

### Example 11

The apparatus of any of the preceding examples 9-10, wherein the means for determining the position comprises at least one of:
a camera configured to determine the position and/or the change in position based on image recognition;
a depth sensor, preferably a photonic mixing sensor;
a marker-based tracking system, the marker-based tracking system comprising at least one sensor-detectable marker attached to the piece of apparel and one or more sensors usable for detecting the position and/or the change in position of the piece of apparel.

### Example 12

The apparatus of any of the preceding examples 8-11, wherein the means for modifying the position of the piece of apparel is a robot arm and/or wherein the modified position of the piece of apparel is determined by the robot arm.

### Example 13

The apparatus of example 12, wherein the robot arm comprises a force momentum sensor for further determining the position of the piece of apparel.

### Example 14

The apparatus of any of the preceding examples 8-13, wherein the means for accepting an input command is configured for controlling the means for projecting and/or the means for modifying the position of the piece of apparel.

### Example 15

The apparatus of any of the preceding examples 8-14, wherein the means for accepting an input command is at least one area of the surface of the piece of apparel itself and/or wherein the means for accepting an input command is a gesture recognition system and/or wherein the input command is submitted by a user.

### Example 16

A method for reversibly modifying the optical appearance of a piece of apparel, the method comprising:
a. determining the position of the piece of apparel;
b. projecting colors, images and/or patterns onto the piece of apparel; and
c. modifying the shape of the piece of apparel, in particular its surface.

### Example 17

The method of example 16, wherein modifying the shape comprises attaching at least one component to and/or removing at least one component from the piece of apparel.

### Example 18

The method of any of the preceding examples 16-17, wherein, when the shape of the piece of apparel is modified, the projecting of colors, images and/or patterns is adapted in accordance with the modified shape.

### Example 19

The method of any of the preceding examples 16-18, wherein projecting colors, images and/or patterns onto the piece of apparel comprises projecting different colors, images and/or patterns to different areas of the piece of apparel.

### Example 20

The method of any of the preceding examples 16-19, wherein the piece of apparel is a shoe.

### Example 21

The method of any of the preceding examples 16-20, further comprising at least one of the following steps:
modifying the position of the piece of apparel,
accepting an input command.

### Example 22

The method of example 16- 21, wherein determining the position comprises determining a change in position of the piece of apparel; and wherein projecting comprises adapting the projecting in accordance with the determined change in position of the piece of apparel.

### Example 23

The method of example 22, wherein determining a change in position of the piece of apparel and/or adapting the projecting is performed in real-time.

### Example 24

The method of any of the preceding examples 21-23, wherein accepting an input command causes the method to modify the projecting and/or to modify the position of the piece of apparel.

### Example 25

The method of any of the preceding examples 21-24, wherein the input command is applied to at least one area of the piece of apparel itself and/or wherein the input command is detectable by a gesture recognition system and/or wherein the input command is submitted by a user.

### Example 26

A computer program comprising instructions for performing the method of any of the examples 16-25.

Different arrangements of the components depicted in the drawings or described above, as well as components and steps not shown or described are possible. Similarly, some features and sub-combinations are useful and may be employed without reference to other features and sub-combinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications may be made without departing from the scope of the claims below.

That which is claimed is:

1. An apparatus for reversibly modifying an appearance of a piece of apparel, the apparatus comprising:
a position-determining system configured for determining a position of the piece of apparel;
a projecting system configured for projecting at least one of colors, images, or patterns onto the piece of apparel; and
a shape-modifying system for modifying a shape of the piece of apparel into a modified shape.

2. The apparatus of claim 1, wherein, in response to the shape of the piece of apparel being modified via the shape-modifying system into a modified shape, the projecting system is configured to adapt the projecting of the at least one of colors, images, or patterns in accordance with the modified shape.

3. The apparatus of claim 1, wherein the projecting comprises projecting at least one of different colors, different images, or different patterns onto different areas of the piece of apparel.

4. The apparatus of claim 1, wherein the shape-modifying system comprises at least one component that is at least one of:
attachable to the piece of apparel; or
removable from the piece of apparel.

5. The apparatus of claim 4, wherein the piece of apparel is a shoe, and wherein the at least one component comprises at least one of:
a heel,
a heel cap,
a quarter,
a top piece,
a throat,
a vamp,
a welt,
a side cage,
a toe cap,
a topline,
shoelaces,
a tongue, or
a sole.

6. The apparatus of claim 4, wherein at least one of:
the at least one component comprises an identification chip, the identification chip comprising information enabling the apparatus to determine a type of the at least one component; or
the at least one component comprises a sensor-detectable marker configured for facilitating detection of at least one of a position or an orientation of the at least one component.

7. The apparatus of claim 4, further comprising:
a grid configured for receiving the at least one component so as to be located on the grid; and
a visual recognition system configured for observing the grid, wherein the visual recognition system is configured to detect removal of the at least one component from the grid.

8. The apparatus of claim 1, wherein the position-determining system is configured to determine a change in position of the piece of apparel; and
wherein the projecting system is configured to adapt the projecting in accordance with the determined change in position of the piece of apparel.

9. The apparatus of claim 8, wherein at least one of determining a change in position of the piece of apparel or adapting the projecting is performed in real-time.

10. The apparatus of claim 1, wherein the position-determining system comprises at least one of:
a camera configured to obtain information for enabling the apparatus to determine at least one of the position or a change in position of the piece of apparel based on image recognition;
a photonic mixing sensor or other depth sensor; or
a marker-based tracking system, the marker-based tracking system comprising at least one sensor-detectable marker attached to the piece of apparel and at least one sensor configured for detecting at least one of the position or a change in position of the piece of apparel.

11. The apparatus of claim 1, further comprising at least one of:
a position-modifying system configured for modifying the position of the piece of apparel into a modified position; or
an input system configured for accepting an input command.

12. The apparatus of claim 11, wherein the apparatus comprises the position-modifying system, wherein the position-modifying system comprises a robot arm and the modified position of the piece of apparel is determined by the robot arm.

13. The apparatus of claim 12, wherein the robot arm comprises a force momentum sensor configured for further determining the position of the piece of apparel.

14. The apparatus of claim 11, wherein the apparatus comprises the input system, wherein the input system is configured for controlling at least one of the projecting system or the position-modifying system.

15. The apparatus of claim 11, wherein the apparatus comprises the input system, wherein at least one of:
the input system comprises at least one area of a surface of the piece of apparel;
the input system comprises a gesture recognition system; or
the input command is submitted by a user.

16. A method for reversibly modifying the optical appearance of a piece of apparel, the method comprising:
determining a position of the piece of apparel;
projecting at least one of colors, images, or patterns onto the piece of apparel; and
modifying a shape of the piece of apparel into a modified shape.

17. The method of claim 16, wherein modifying the shape comprises at least one of:
attaching at least one component to the piece of apparel; or
removing at least one component from the piece of apparel.

18. The method claim 16, wherein the projecting at least one of colors, images, or patterns onto the piece of apparel comprises projecting at least one of different colors, different images, or different patterns onto different areas of the piece of apparel.

19. The method of claim 16, wherein the piece of apparel is a shoe.

20. The method of claim 16, further comprising accepting an input command, wherein at least one of:
the input command is applied to at least one area of the piece of apparel; or
the input command is detectable by a gesture recognition system; or
the input command is submitted by a user.

21. A non-transitory computer-readable storage medium having stored therein instructions that, when executed by one or more processors of a computer system, cause the computer system to at least:
determine a position of a piece of apparel;
cause projecting of at least one of colors, images, or patterns onto the piece of apparel; and
cause a modifying of a shape of the piece of apparel into a modified shape.

22. The non-transitory computer-readable storage medium of claim 21, wherein the instructions further cause the computer system to, in response to the shape of the piece of apparel being modified into a modified shape, cause the projecting of at least one of colors, images, or patterns to be adapted in accordance with the modified shape.

23. The non-transitory computer-readable storage medium of claim 21, wherein the instructions further cause the computer system to at least one of:
cause the position of the piece of apparel to be modified, or
accept an input command.

24. The non-transitory computer-readable storage medium of claim 21, wherein the instructions further cause the computer system to:
determine a change in position of the piece of apparel; and
cause the projecting to be adapted in accordance with the determined change in position of the piece of apparel.

25. The non-transitory computer-readable storage medium of claim 24, wherein the instructions further cause the computer system to:
determine the change in position of the piece of apparel or cause the projecting to be adapted in real-time.

26. The non-transitory computer-readable storage medium of claim 21, wherein the instructions further cause the computer system to:
accept an input command; and
cause a modification to at least one of the projecting or a position of the piece of apparel in response to the input command.
